(19) United States
(12) Patent Application Publication
(10) Pub. No.: US 2020/0138001 A1
(43) Pub. Date: May 7, 2020

(54) SHOE FOR HORSES, IN PARTICULAR FOR RACEHORSES

(71) Applicant: WINNER AG, Chur (CH)

(72) Inventors: Martin Zindel, Landquart (CH); Christian Lampert, Jenins (CH)

(21) Appl. No.: 16/612,709

(22) PCT Filed: May 9, 2018
(86) PCT No.: PCT/CH2018/050016

§ 371 Date: Nov. 11, 2019

(30) Foreign Application Priority Data
May 10, 2017 (CH) 00628/17

(51) Int. Cl. A01L 5/00; A01L 1/02; B29C 45/00; B29C 45/14; B29B 13/06; B29C 45/73

(52) U.S. Cl. CPC A01L 5/00; A01L 1/02; B29C 45/0001; B29K 2069/00; B29C 45/0055; B29B 13/06; B29C 45/73; B29C 45/14786

(57) ABSTRACT

A horseshoe for horses, in particular for racehorses when taking part in competitions. The horseshoe is produced from thermoplastic polymer material or from fiber-reinforced thermoplastic polymer material. The thermoplastic polymer material is selected from thermoplastic polycarbonates or fiber-reinforced thermoplastic polycarbonates. The horseshoe may be constructed from a core of fiber-reinforced plastic material, which is sheathed in a functional layer made of plastic. The core may also be formed from a fiber-reinforced thermoplastic polymer material, such as a fiber-reinforced thermoplastic, and the functional layer may be formed from a thermoplastic polycarbonate material or a fiber-reinforced thermoplastic polycarbonate material, such as a thermoplastic or a fiber-reinforced thermoplastic. The horseshoe may be produced by thermoplastic injection molding methods.

### CROSS-REFERENCE TO RELATED APPLICATIONS

This application is a national phase entry under 35 U.S.C. § 371 of PCT/CH2018/050016 filed May 9, 2018, which claims priority to Swiss Patent Application No. 00628/17 filed May 10, 2017, the entirety of each of which is incorporated by this reference.

### TECHNICAL FIELD OF THE INVENTION

The invention relates to a horseshoe containing plastic materials with or without a reinforcing core, especially fiber-reinforced plastic materials. In one advantageous embodiment, the invention relates to a horseshoe substantially containing a core made of fiber-reinforced plastic material and a functional layer sheathing the core made of plastic material, especially made of fiber-reinforced plastic material. The shoes according to the invention are suitable for sporting horses, especially racehorses used in competition.

### BACKGROUND OF THE INVENTION

The shoes most often used in the past for racehorses normally consist of aluminum. This kind of horseshoe is relatively light (around 127 grams), but quite rigid and firm. There is slight abrasion of the aluminum shoe. An aluminum shoe will hold up for around 5 weeks, but then the horse must be shod once more. This is also especially due to further growth of the hoof.

The patent application US 2010/0276163 A1 alternatively proposes a horseshoe made of fiber-reinforced plastic, which protects the horse' hoof against abrasion and is relatively light. In one variant, the mentioned application also proposes a plastic bottom layer which is supposed to protect the fiber composite against erosion, while at the same time increasing the static friction on hard ground, such as concrete or asphalt, and dampening the impact.

In patent application WO 87/06097 A1 there is proposed a metal core with elastic rubber sheathing, which is supposed to have as much as possible the properties of the natural horse sole. In documents GB 2 222 757 A, U.S. Pat. No. 4,972,909 A and WO 2004/023871 A1, horseshoes are proposed with fiber-reinforced plastic core and plastic sheathing of the most diverse material combinations. Polyurethanes are often used. The examples mentioned there also in particular aim at achieving a high shock absorption and/or allowing a certain natural mobility of the hoof in order to prevent problems with the musculoskeletal system.

In many kinds of equestrian sports, and most particularly in racing, durable horseshoes are a must in order to compete successfully in the sport; this also includes regular and intensive training. Besides the durability or toughness of a horseshoe, the performance of the animal is of special interest in the sport. The shoes available today are not optimal, especially for horseracing, since on the one hand they are not tough enough and/or they adversely affect the performance of the horse, for example by heavy weight, unfavorable ground adherence, slippage properties and/or dampening properties.

The patent application CH710762 (A2) describes a horseshoe for racehorses which, in the examples relevant to the invention, consists of a fiber-reinforced thermoset core (for example, a carbon fiber-reinforced epoxy resin), which is coated with a wear layer of plastic, for example being made from a wear layer of thermosetting or thermoplastic polyurethane resin. These shoes are quite light and should have high strength and durability on account of the fiber-reinforced thermoset core. It has been shown that the effective racing performance of a horse increases on account of the reduced weight of a horseshoe strengthened with carbon fibers. However, it has been found that the horseshoes often have unexpected breakage after a short time in use, making the horseshoe unusable and needing to be replaced prematurely. Furthermore, depending on the extent of training and the quality of the ground, it has been found that the abrasion was not optimal, which may shorten the lifetime of the horseshoe and impair the grip properties of the horseshoe.

### The Problem

Therefore, one problem which the present invention proposes to solve it to provide a horseshoe for sporting horses, especially racehorses, with which the horses can attain high running speeds. Moreover, the problem of the present invention is to largely eliminate the aforementioned drawbacks and to provide a horseshoe having low abrasion with low weight, so that it can be used as long as possible, especially for at least four weeks, or be left on the hoof. Moreover, the horseshoe should provide a good grip, prevent sinking into the ground as much as possible, and remain as free of ground material as possible. Furthermore, the risk of breaking the horseshoe during use (training and racing) should be as little as possible. Another problem of the present invention is to provide a horseshoe which can be produced as easily and economically as possible in the factory.

### SUMMARY

These and other goals are achieved by the features of the independent patent claims. Modifications and/or advantageous variant embodiments are the subject matter of the dependent claims.

This invention fulfills the above requirements in that it provides a horseshoe, especially for racehorses used in competition, which is substantially made of or consists of a thermoplastic polymer and/or fiber-reinforced thermoplastic polymer material. The thermoplastic polymer material is advantageously chosen from the group of the thermoplastic polycarbonates, the fiber-reinforced thermoplastic polycarbonates, or a combination of these.

In a first embodiment, a horseshoe is provided, especially for racehorses used in competition, constructed from a core made of fiber-reinforced plastic material, which is sheathed in a functional layer made of plastic. The core is substantially formed of a fiber-reinforced thermoplastic polymer material (i.e., a fiber-reinforced thermoplastic) and the functional layer is substantially formed from a thermoplastic polymer material (i.e., a thermoplastic or a fiber-reinforced thermoplastic). The core is substantially coated or sheathed by the functional layer.

The thermoplastic polymer material of the functional layer is chosen from the group of the polycarbonates (PC). Advantageously, this is furthermore fiber-reinforced. The abrasion behavior of this material proves to be especially favorable for horseshoes, especially those of racehorses.

The thermoplastic polymer material of the core or the matrix of the fiber composite core can be chosen from the group of the polycarbonates (PC). It is especially advantageous when the fibers are present as a fabric which is embedded in the polymer matrix. The strength, elasticity and rigidity of the material prove to be especially favorable for horseshoes, especially those of racehorses.

The use of thermoplastic polycarbonate (PC) has proven to be especially advantageous for the core or the core matrix and the functional layer. This material combination enables especially good binding conditions between core and functional layer. Furthermore, the material combination has especially advantageous properties for horseshoes, especially in regard to the strength, elasticity, rigidity and abrasion behavior. A further advantage of the mentioned material combination results from the additional possibility of thermally deforming the horseshoe in order to achieve a better fit.

The horseshoe according to the present invention brings in physical respects the elementary benefit of reduced weight. In addition, the horseshoe according to the invention brings additional advantages in a medical and application respect. The benefits as compared to traditional horseshoes, such as iron and aluminum, are better dampening, which results in less strain on the tendons and joints, better elasticity for the proper movement of the hoof, resulting in lower energy expenditure, and less weight, and thus less inertia with good slipping and sliding stability at the same time. On the whole, this results in an optimized movement of the racehorse in a gallop. Further benefits as opposed to other horseshoes with fiber composite core are an improved bonding between core and functional layer, which adhere to each other even under heavy strain (during racing conditions).

The core of the horseshoe may be coated at least on the running surface and all shoe edges. More particularly, the core may be substantially coated on all sides, i.e., on the running surface, the hoof side and the side surfaces connecting the running surface and the hoof side on the inside and the outside.

The fibers reinforcing the core may be chosen from the group consisting for example of carbon fibers (also known as carbon filaments), polymer fibers, glass fibers and combinations of these.

The fiber reinforcement of the core advisedly contains substantially long fibers or quasi-endless fibers. Long fibers are in particular fibers with a length of at least 20 mm, preferably at least 50 mm, or longer.

The fibers reinforcing the core may be arranged in one or more layers, e.g., the fibers of one layer form a braid, a knit, or a fabric. A braid, a knit, or a fabric can be made, e.g., of long or endless fibers. If several layers are present, the fiber orientation in the different layers is different. The fibers of each layer may be present as a fabric. In one embodiment, the core contains, e.g., in alternating sequence, fabric layers made of carbon fibers and fabric layers made of glass fibers, which are embedded in a thermoplastic matrix. The core consists of multiple layers of continuous reinforcement fibers which are embedded in a matrix of technical-grade thermoplastic.

The thermoplastic polymer material of the functional layer may be fiber-reinforced, e.g., with plastic fibers, carbon fibers and/or glass fibers.

Advisedly short fibers can be used for the fiber reinforcement of the functional layer, and mixed in with the thermoplastic polymer material of the functional layer. Short fibers with a length of less than 20 mm, less than 10 mm, less than 1 mm, or having a length between 0.1 and 1 mm, for example also whiskers. Advisedly, short fibers have substantially a length of 0.01 mm to 1 mm, 0.05 mm to 0.5 mm, or 0.1 mm to 0.3 mm.

The thermoplastic polymer material for the functional layer may advantageously be chosen from the group consisting of fiber-reinforced polycarbonate, a polycarbonate reinforced with 10 wt. % to 50 wt. % of fibers, a polycarbonate reinforced with 20 wt. % to 40 wt. % of fibers, or a polycarbonate reinforced with 25 wt. % to 35 wt. % of fibers. Glass fiber-reinforced polycarbonate, such as PC-GF30, has proven to be especially serviceable.

A fiber blend of glass fibers and carbon fibers has proven to be especially advantageous. A functional layer of polycarbonate may be reinforced with 20 wt. % to 40 wt. % of glass fibers and 10 wt. % to 30 wt. % of carbon fibers, a polycarbonate reinforced with 25 wt. % to 35 wt. % of glass fibers and 15 wt. % to 25 wt. % of carbon fibers, or a polycarbonate reinforced with 28 wt. % to 32 wt. % of glass fibers and 18 wt. % to 22 wt. % of carbon fibers. It may be advantageous to restrict the fiber blend indicated in this section to a total fiber content as described in the preceding section, i.e., 10 wt. % to 50 wt. % fibers in a polycarbonate matrix.

The material of the functional layer can be applied to the core by injection molding, for example. In order to form the horseshoe, an injection mold can be used in which the core has been previously placed in the mold. Injection molding is a possible method of production. In any case, the goal is to create a permanent bond between core and functional layer of the horseshoe.

The core is advisedly produced from a plate of plastic fiber composite or from fiber-reinforced thermoplastic polymer material. The plate may be trimmed to size by water jet cutting.

Optionally, an abrasion protection may be integrated in the horseshoe, consisting of a material which is more abrasion resistant than the functional layer. The abrasion protection may be formed substantially of a metal strip, e.g., a steel strip, made of tool steel. The abrasion protection is integrated in the horseshoe by being embedded in the horseshoe and penetrating at least as far as the horseshoe surface, e.g., in order to form the surface together with the horseshoe material surrounding it. The abrasion protection forms a flush surface with the surrounding horseshoe material.

Advantageously, the abrasion protection is anchored in the core, for example, in that the core has indentations or through holes in the front region of the horseshoe, which serve for the attachment of the abrasion protection to the core toward the running surface. For this purpose, the abrasion protection has protuberances, for example, which are designed to install the abrasion protection by means of the protuberances in the indentations or through holes (e.g., by insertion) and possibly to fasten it in this way. The abrasion protection integrated in the horseshoe is substantially arranged at a distance from the core, on the running surface side from the core.

The horseshoe substantially has the shape of a U-shaped curved strip, possibly provided with holes for horseshoe nails.

The horseshoe according to the invention is designed for fastening to the horse' hoof by nails. The horseshoe optionally has a bottom-side groove, in which square holes for nails for fastening to the horse' hoof are or can be devised. This design likewise serves for a good ground grip or acts as a slippage protection. But the fastening to the horse' hoof can also be done alternatively by gluing.

Further, a method for production of a horseshoe is disclosed here. The horseshoe can be produced, e.g., by means of extrusion methods and by means of injection molding methods (thermoplastic injection molding methods).

The horseshoe may be produced by melting a thermoplastic polymer material (i.e., polycarbonate or fiber-reinforced polycarbonate, for example), placing a plastic fiber composite core (i.e., a core of fiber-reinforced thermoplastic material, for example) in a mold, and surrounding or ensheathing or injecting around the plastic fiber composite core with the molten thermoplastic polymer material. After the curing of the thermoplastic polymer material, this forms a functional layer which substantially ensheathes the core.

A blend of molten thermoplastic polymer material and fibers, especially short fibers, can be applied as a functional layer to the core via an extruder or injection molding layout.

A thermoplastic polycarbonate may be used for the functional layer which can be melted for example at a temperature of 260° C. to 340° C., preferably at a temperature of 280° C. to 320° C.

The polymer material for the functional layer is advisedly injected with a specific injection pressure of 800 bar to 1400 bar into the mold. This pressure is especially favorable for the processing of thermoplastic polycarbonate.

The mold may be preheated, e.g., to 80° C. to 130° C., preferably to 80° C. to 120° C., before the molten polymer material is injected. The indicated temperatures for the preheating are especially favorable when processing a thermoplastic polycarbonate.

Further, the polymer material for the functional layer may be previously dried prior to the melting, e.g., at 100° C. to 130° C., preferably at 100° C. to 120° C. The indicated temperatures are especially favorable for the preliminary drying of thermoplastic polycarbonate. Normally, the preliminary drying is done between 2 and 8 hours.

The casting or injection molding mold can be equipped with support structures, especially support pins, by means of which the plastic fiber composite core can be supported at a distance from the molding surfaces or positioned firmly inside the mold.

Advisedly, at least four support structures (e.g., as support pins), such as at least 6 support structures, or at least 10 support structures are present for supporting the plastic fiber composite core. These are arranged in the mold and distributed evenly along the curved longitudinal extension of the U-shaped mold, in order to support as evenly as possible a similarly shaped U-shaped core to be inserted. These support structures may in part be at the same time those molding parts which are used for producing the nail holes.

Optionally, the mold is equipped with mold inserts or inserts are provided in the mold, by means of which material cutouts and/or continuous hole cutouts can be produced in the horseshoe.

Advantageously, the support structures or support pins and/or mold inserts are made of metal, e.g., steel, especially tool steel. So that the support structures or support pins and/or mold inserts do not remain in the horseshoe when the finished horseshoe is knocked out from the mold, the support structures or support pins and/or mold inserts are secured in the mold.

If the plastic fiber composite core is provided with an abrasion protection, this may serve in the mold as a further support structure for the plastic fiber composite core. However, the abrasion protection is not secured or anchored in the mold, since it should be ejected from the mold together with the finished horseshoe. The abrasion protection and the plastic fiber composite core are substantially embedded at the same time in the molten polymer material during the injection molding process and are thereby integrated in the horseshoe.

Furthermore, the production method is optionally characterized in that, after the sheathing or after the injecting around the core (by injection molding), the horseshoe is cooled down for the curing and after the curing the curvature of the horseshoe is adapted to a predetermined fit by mechanical deformation, such as pressing or pulling, at a higher temperature than room temperature. In order to prepare the horseshoe for the machining, it is heated to a higher temperature than room temperature, at which the material or the matrix material of the core and the functional layer is softened and becomes plastically deformable under force or pressing and pulling. Said increased temperature advisedly lies in a range above the temperatures occurring during the use of the horseshoe, i.e., for example at over 100° C., in the range of 120° C. to 160° C. or in the range of 130° C. to 150° C., or at 140° C. Polycarbonates in particular, especially a fiber-reinforced polycarbonate core as described above and a fiber-reinforced polycarbonate functional layer as described above are mechanically deformable at these temperatures to a sufficient degree for the application purpose.

Furthermore, there also results from this a method for shoeing a horse' hoof in that the horseshoe is adapted at higher temperature than room temperature, preferably in a range above 100° C., especially for example in the range of 120° C. to 160° C., or in the range of 130° C. to 150° C., by mechanical deformation such as pressing or pulling to the shape of the hoof being shod.

In a second embodiment, a horseshoe is provided in particular from a fiber-reinforced thermoplastic polymer material or in particular from a fiber-reinforced thermoplastic polycarbonate, containing 20 wt. % to 40 wt. % glass fiber and 10 wt. % to 30 wt. % carbon fiber. The thermoplastic polymer material or the thermoplastic polycarbonate contains 25 wt. % to 35 wt. % of glass fibers and 15 wt. % to 25 wt. % of carbon fibers. Further, the thermoplastic polymer material or the thermoplastic polycarbonate may contain 28 wt. % to 32 wt. % of glass fiber and 18 wt. % to 22 wt. % of carbon fiber.

The polycarbonate material reinforced with two different fiber materials is surprisingly suitable not only as a functional layer material in combination with a core for horseshoes (as described above in the first variant embodiment), but also as a full material (i.e., without some other reinforcing core, i.e., especially without a fabric core) or as an entirely uniform fiber composite material (i.e., of the same kind, especially the same fiber), especially as a short fiber composite material. The full material variant can be produced especially economically and is therefore especially advantageous.

Hence, in an especially economical embodiment, the entire horseshoe or at least the essential portion of the horseshoe may consist of a thermoplastic polycarbonate reinforced with 20 wt. % to 40 wt. % of glass fiber and 10 wt. % to 30 wt. % of carbon fiber. The essential portion of the horseshoe is defined as being, e.g., a portion of at least 90 wt. % of the horseshoe. Alternatively, the essential portion of the horseshoe is defined as being, e.g., a portion of at least 95 wt. % or further alternatively a portion of at least 98 wt. % of the horseshoe.

Short fibers, especially fibers with a length of less than 20 mm, preferably less than 10 mm, less than 1 mm, or a length between 0.1 and 1 mm, are usable. Advisedly, short fibers have e.g. a length of substantially 0.01 mm to 1 mm, 0.05 mm to 0.5 mm, or 0.1 mm to 0.3 mm.

Advisedly, an abrasion protection may be integrated in the horseshoe, which consists of a material (such as steel, especially tool steel) which is more abrasion-resistant than the fiber-reinforced thermoplastic polymer material or which is more abrasion-resistant than the fiber-reinforced thermoplastic polycarbonate. By weight percent, such an abrasion protection makes up, e.g., 10 wt. % or less of the horseshoe, 5 wt. % or less of the horseshoe or 2 wt. % or less of the horseshoe.

The advantageous variant embodiments presented in the following in themselves or in combination with each other lead to further improvements of the subject matter of the invention.

### DESCRIPTION OF FIGURES

Further benefits and features of the horseshoe according to the invention will emerge from the following description of an exemplary embodiment of the invention making reference to schematic representations. The preferred features mentioned may be implemented in any given combination—as long as they are not mutually exclusive. There are shown, in a schematic representation not true to scale:

FIG. 1: a view of a horseshoe according to the invention for the fore leg, (a) bottom-side view of the horseshoe, (b) hoof-side view of the horseshoe, (c) side view;

FIG. 2: a view of a horseshoe according to the invention for the hind leg, (a) bottom-side view of the horseshoe, (b) hoof-side view of the horseshoe, (c) side view;

FIG. 3: a top view and a side view of a core (without functional layer) of a horseshoe according to the invention for the fore leg;

FIG. 4: a top view and a side view of a core (without functional layer) of a horseshoe according to the invention for the hind leg;

FIG. 5: abrasion protection strip in three views: (a) running surface side, (b) from the rear, (c) laterally;

FIG. 6: a running-surface view (a) of a horseshoe according to the invention for the fore leg showing two cross section levels, (b) section level view A-A (on enlarged scale 2:1 as compared to (a), (c) section level view B-B (on enlarged scale 2:1 as compared to (a);

FIG. 7: half of an injection mold for the running-surface side of the horseshoe, for the fore leg;

FIG. 8: half of an injection mold for the hoof side of the horseshoe, for the fore leg;

FIG. 9: an enlarged partial cutout of FIG. 8.

### DETAILED DESCRIPTION

In the following, the same reference numbers stand for the same or functionally identical elements in the same or different figures. An added apostrophe may designate partial regions.

In order to protect the hoof, horseshoes are normally secured on the running surface side by nails at the outer margin of the horny portion of the hoof. Horseshoes protect and support in particular the margin of the hoof wall at the ground side. The shape of a horseshoe may be designated for the most part as a U-shaped partial ring or bow, with a running surface at the ground side and a contact surface at the hoof side. Optionally, a groove is designed at the middle of the shoe on the running surface side (i.e., the ground side), where the holes for the nails can also be made.

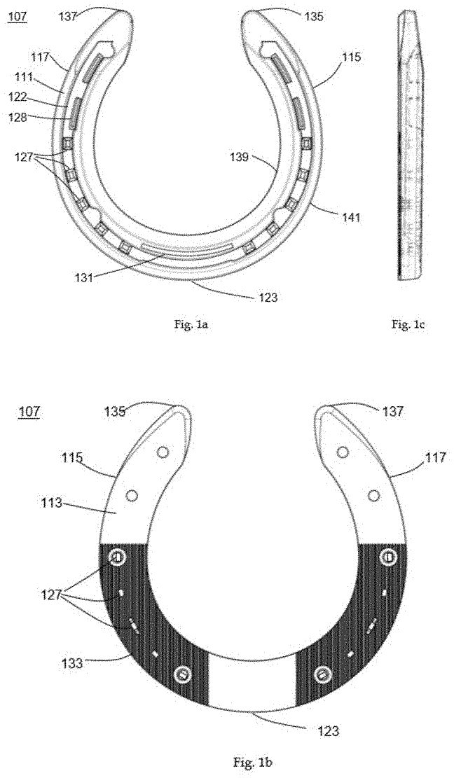

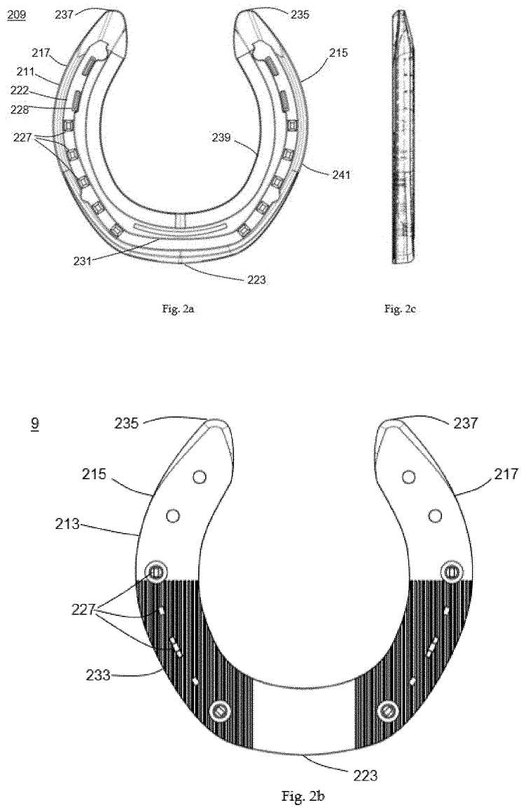

FIGS. 1a and 1b show a horseshoe 107 according to the invention for the fore leg of horses in two views, i.e., the running surface (i.e., the bottom side) 111 (FIG. 1a) and the hoof side 113 (FIG. 1b). FIGS. 2a and 2b show a horseshoe 207 according to the invention for the hind leg of horses in two views, i.e., the running surface (i.e., the bottom side) 211 (FIG. 2a) and the hoof side 213 (FIG. 2b). A typical horseshoe 107, 207 is basically curved in a U shape. The typical horseshoe 107 or 207 thus has a central region 123, 223 (also called the front region) as well as two side shanks 115, 117, 215, 217 running backward from the central or front region (respectively the right and left shank). The shanks are spaced apart from each other, but usually taper toward each other, and each of them has a free end 135, 137 and 235, 237. On the shod hoof, the central region 123, 223, marking the position of the tiptoe (by which the horse can basically push off when running), points in the forward direction or the running direction, while the free shank ends 135, 137, 235, 237 point from the tiptoe substantially backward or in the opposite running direction. Depending on the anatomical shape of the hoof, the horseshoe 107 may be designed more round for the fore leg than the horseshoe 207 for the hind leg, which is more elongated in comparison. Horseshoes are secured to the hoof wall margin on the sole side. Horseshoes are advisedly prepared in different sizes, so that depending on the side of the horse' hoof a properly fitting or shaped horseshoe can be selected. If the horseshoe is deformable, e.g., because it is made of a thermoplastic which can be deformed at elevated temperature, then the shape of the shoe can be adapted individually to the hoof, thereby accomplishing a more exact fit.

On the running surface side, horseshoes 107, 207 basically have a more or less flat U-shaped surface 111, 211, which is usually designed with a plurality of continuous square nail holes 127, 227 for the fastening to the hoof, being divided at the running surface side into left and right on the respective two shanks 115 and 117 or 215 and 217 and arranged in a row along them. In the example shown here in FIGS. 1a and 2a, respectively 10 nail holes are shown, divided between 5 nail holes on each shank.

The edges of the nail holes 127, 227 are broken at the bottom side, so that the nail heads can be driven in as flush as possible at the level of the running surface. Optionally, a groove (or also a furrow) 122, 222 may run down the center of the running surface, being oriented to the length of the shank, and the nail holes are arranged inside the groove or furrow 122, 222. The groove or furrow 122, 222 furthermore enhances the gripping ability and reduces the weight of the horseshoe.

At the hoof side, one can also see the nail holes 127, 227, since these lead from the running surface 111, 211 to the hoof side 113, 213 through the horseshoe.

As an alternative to the nails, the horseshoe may also be secured by gluing. At the hoof side, the surface 113, 213 of the horseshoe 107, 207 may be roughened or structured. On account of the increased surface in a roughened or structured surface region 133, 233, the adherence between hoof and the horseshoe is especially good when using adhesive. For this purpose, at least the hoof-side surface 113, 213 of the horseshoe is roughened or structured in the region 133, 233 of the nail holes 127, 227.

In order to achieve the lowest possible weight of the horseshoe, the horseshoe may be provided with cutouts 128, 228. These material cutouts are advantageously arranged in the rear shank region behind the nail holes.

At the hoof side, several of the nail holes may be round, on account of the production process, which will be explained further below.

In the front horseshoe region or in the tiptoe region 123, 223, an insert 131, 231 for wear protection, especially for abrasion protection, also called here an abrasion protection or abrasion protection insert, is embedded in the horseshoe 107, 207 at the bottom side. This is advisedly made of an especially abrasion-resistant material such as metal, especially steel, e.g., tool steel. The abrasion protection insert 131, 231 advantageously protrudes as a curved strip, which is arranged parallel to the furrow 122, 222 and thus substantially transversely to the running direction. In the example shown here (FIGS. 2a and 2b), the abrasion protection insert 131, 231 is arranged behind the furrow 122, 222 with respect to the running direction. The abrasion protection reduces the abrasion of the functional layer, which in particular increases the durability of the shoe.

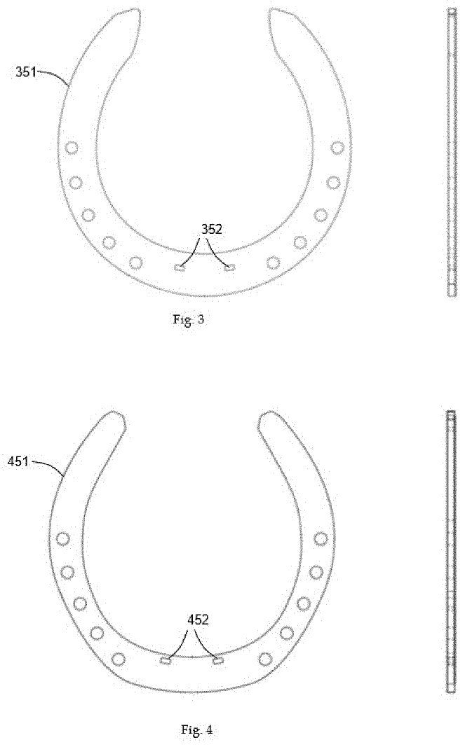

The horseshoe 107, 207 comprises a core 351, 451. A typical core for a fore leg horseshoe and a hind leg horseshoe is shown in top view and side view respectively in FIG. 3 and FIG. 4. The core 351, 451 gives the horseshoe 107, 207 the desired strength and rigidity, depending on the choice of material. The shape of the core 351, 451 for a typical horseshoe 107, 207 is similar to the finished horseshoe 107, 207, but less in its spatial extension. The shape of the core 351, 451 is a U in particular and thus it has a central front toe region as well as two side shanks running backward from the central toe region. Holes 355, 455 for nails are advantageously situated in the core 351, 451. These holes 355, 455 are larger than the nail holes leading through the finished horseshoe. Moreover, insertion holes 352, 452 (at least two rectangular insertion holes, for example) are present in the front region of the core, suitable for the insertion of an abrasion protection 131.

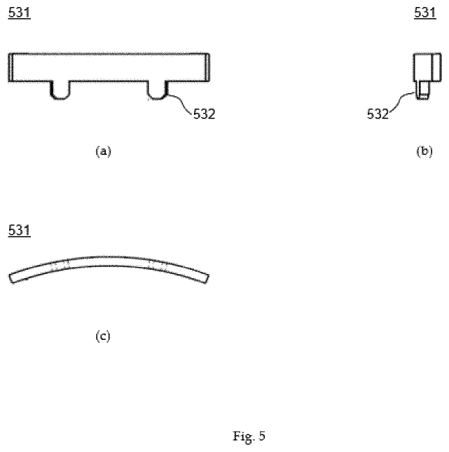

An exemplary abrasion protection 531 is shown in FIG. 5 in three top views. This involves a strip, made of tool steel with one, two or more pluglike protrusions 532 pointing in the same direction on one lengthwise side. The strip is curved, in particular curved about an axis parallel to the orientation of the protrusions. The curvature is advisedly similar to the curvature of the horseshoe 107 in the toe region. In order to make an abrasion protection, it can be cut out from a plate, for example with a laser. The edges of the cut portion are sand blasted to break the edges.

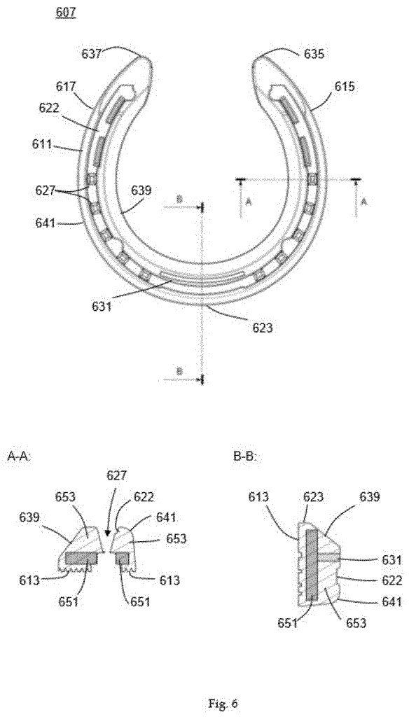

The core 351, 451 is substantially sheathed with a functional layer 653. FIG. 6 shows two cross sectional drawings, A-A and B-B, of different regions of a fore leg horseshoe 607. Cross sectional drawing A-A shows a cross section across a nail hole 627 on the right shank 615 of the horseshoe 607. Cross sectional drawing B-B shows a cross section in the front region or in the toe region of the horseshoe 607.

At the outside of the horseshoe, the edge 641 of the horseshoe 607 is broken or rounded at the running surface side or bottom side and it forms a slight rounding 641. This is favorable for the unhindered forward movement of the horse, in this way the hoof remains less hanging on the ground, i.e., the risk of stumbling is reduced, but at the same time the support during push-off is quite good. As compared to the ground-side outer edge 641 of the horseshoe, the ground-side inner edge 639 is distinctly more beveled or the edge is substantially removed and forms instead a slanted surface, which during ground contact recedes from the ground, starting at the bottom side 611 of the horseshoe. Furthermore, the ground-side inner and outer edges are usually likewise distinctly beveled at the shank ends 635, 637. In this way, the hoof after contacting the ground can be more easily detached from the ground and the hoof experiences less resistance.

In each of the cross sections A-A and B-B, the horseshoe core 651 and the surrounding functional layer 653 are shown. In FIG. 2a, the cross section extends across the square nail hole 627. Portions of the core 651 and portions of the functional layer 653 are shown at left and right of the nail hole 627. The nail hole is situated in the furrow 622. On the running surface side (i.e., the bottom side), the functional layer 653 advisedly has a greater layer thickness than on the hoof side (i.e., the sole side). The functional layer on the running surface side (i.e., the bottom side) is many times thicker than the hoof-side functional layer. The layer thickness of the hoof-side functional layer as measured from the core 651 is less than 2 mm, or less than 1 mm. The layer thickness of the bottom-side functional layer measured from the core 651 is greater than 2 mm, greater than 3 mm or greater than 4 mm. On the running surface side, the functional layer thickness corresponds roughly to the core thickness or is greater than the core thickness. The thickness of the core 651 may be, e.g., in the range of 3 to 8 mm. The thickness of the functional layer on the running surface side may be, e.g., in the range of 3 to 8 mm. The thickness of the horseshoe itself is, e.g., in the range of 6 to 16 mm or in the range of 9 to 12 mm. The hoof side (or sole side) 613 of the shoe may be structured.

An abrasion protection 631 is embedded in the functional layer 653. Advantageously, an abrasion protection insert 631 is embedded at least in the toe region 623 of the horseshoe. The abrasion protection 631 and the core 651 are advisedly joined together, for example, in that the abrasion protection 631 is inserted into the core 651—at least at two points. In this way, the construction of the core, the functional layer and the abrasion protection is optimally stable. The abrasion protection insert 631 secured in the core may additionally act in stabilizing manner on the connection between the core 651 and the functional layer 653—this may be important primarily in the toe region 623, where strong shear forces may be acting between the core and the functional layer.

For weight reasons, the horseshoe is made of plastic or plastic fiber composite. In order to obtain especially good strength properties coupled with good gripping properties and further coupled with good dampening properties, a composite of long fiber-reinforced or endless fiber-reinforced thermoplastic material is proposed for the core (e.g., carbon fiber and/or glass fiber in a thermoplastic matrix, especially e.g. in a polycarbonate matrix) and a thermoplastic material or optionally a short fiber-reinforced thermoplastic material for the functional layer (e.g., polycarbonate with or without glass fiber reinforcement). Thus, the horseshoe according to the invention consists of a fiber-reinforced thermoplastic core and a functional layer made of thermoplastic with or without fiber reinforcement. The fiber reinforcement of the core advisedly contains long fibers or endless fibers, i.e., for example fibers with a length of 20 mm or more, or 50 mm or more. The fiber reinforcement of the functional layer advisedly contains short fibers, i.e., for example fibers with a length of less than 20 mm, or less than 10 mm, with a length in the range of 0.1 to 1 mm.

On account of the fiber reinforced thermoplastic material used for the core, the core is durable, rigid, and at the same time light. Thus, the horseshoe according to the invention is particularly light as compared to traditional horseshoes made of metal, such as iron or aluminum. As compared to known horseshoes with fiber-reinforced thermosetting core, the present core made from fiber-reinforced thermoplastic material is especially advantageous, since it has little or no tendency to break and furthermore it is deformable at elevated temperatures, allowing a better shape fitting to the individual horse hoof. The thermoplastic functional layer material is chosen on the basis of its advantageous abrasion properties and at the same time good adhesion properties on the core material; in particular, no detachment between the core and the functional layer should occur for a period of at least 4 or 5 weeks and the abrasion during normal use (i.e., on the shod hoof) or usual training procedures during this period should not result in major damage or changes of shape of the horseshoe. If the same thermoplastic material is chosen for the matrix of the core and the functional layer, an especially good adherence will result between the core and the functional layer.

The forming of cavities or cutouts in the horseshoe, especially in the functional layer, may further reduce the weight. In particular, the lower weight, a certain cushioning action and a less restricted blood flow in the hoof as compared to traditional horseshoes are among the benefits of plastic horseshoes in themselves. Further benefits of the plastic horseshoe according to the invention as compared to known plastic horseshoes which come to bear especially for racehorses are less depth of sinking into the ground, better grip and reduced abrasion and wear. A further benefit is the good individual adaptability or shapeability of the thermoplastic horseshoe, especially by individual deforming (e.g., widening or narrowing) of each individual horseshoe before it is applied.

The design described in the figures for front and hind hoof assures an optimal grip, reduces the depth of sinking, and reduces the uptake of dirt, which likewise results in an energy savings.

In the following, a production method will be indicated for the horseshoe.

The horseshoe is made by means of a thermoplastic injection molding process. The core may be produced by cutting out, especially by water jet cutting from a plate of thermoplastic fiber composite. The material of the functional layer is advantageously placed on the core to form the shoe shape by extruder or injection molding layouts.

For this, a core 351, 451 and optionally an abrasion protection 631 are placed in an injection molding die and overmolded with functional layer material. As the core material, a fiber-reinforced thermoplastic is employed, such as a carbon fiber/thermoplastic composite, a glass fiber/thermoplastic composite or a glass fiber/carbon fiber/thermoplastic composite, especially e.g. a carbon fiber/polycarbonate composite, a glass fiber/polycarbonate composite or a glass fiber/carbon fiber/polycarbonate composite. The fibers contained in the composite material of the core are long fibers or endless fibers. The processed functional layer material is likewise a thermoplastic, preferably a fiber-reinforced thermoplastic. A polycarbonate is reinforced with glass fibers; optionally, other fibers can be used, such as carbon fibers. Glass fibers, especially a polycarbonate with 30 wt. % of glass fiber (PC-GF30) may be used. Advisedly, the fibers of the functional layer material are short fibers. Optionally, the functional layer material may be dried prior to its use in the injection molding. The preliminary drying in the case of polycarbonate material, especially glass fiber-reinforced polycarbonate material, can be done for example at around 120° C. (e.g., for 2 to 8 hours). For the injection molding, the functional layer material is melted and injected under pressure into an injection molding die. The injection molding die may be preheated. Polycarbonate material, especially polycarbonate with 30 wt. % of glass fiber, is melted with a temperature of 280° C. to 320° C. and injected with a specific injection pressure of 800 bar to 1400 bar into an injection molding die heated to 80° C. to 130° C. After the cooldown phase, the horseshoe can be removed from the die.

In an injection molding production method, a core of a composite is made from a fabric of carbon fiber and glass fiber in a matrix of thermoplastic polycarbonate. This core is placed in an injection molding die. Furthermore, a polycarbonate material with or without glass fiber reinforcement is dried at 100° C. to 120° C. After this, the dried polycarbonate material is melted with a temperature of 280° C. to 320° C. and injected with a specific injection pressure of 800 bar to 1400 bar into an injection molding die heated to 80° C. to 120° C. After the cooldown phase, the horseshoe can be removed from the die.

A core/functional layer composite or the horseshoe can be produced—as explained above—by injecting the functional layer onto the core.

The abrasion protection is made from a metal, such as steel or tool steel. But other materials are also suitable, as long as they are more abrasion resistant than the functional layer.

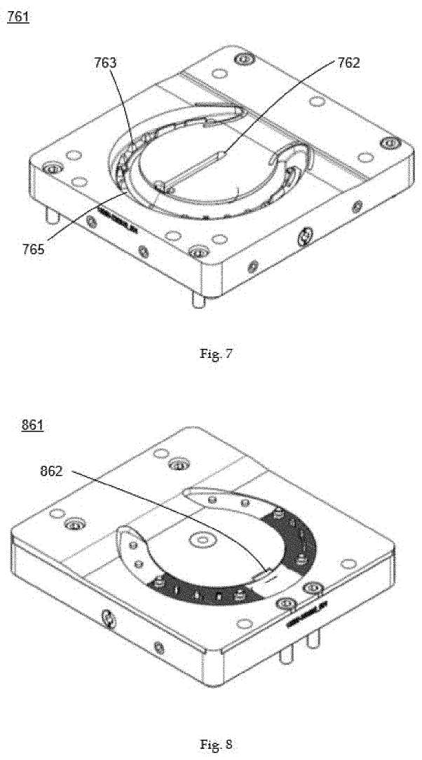

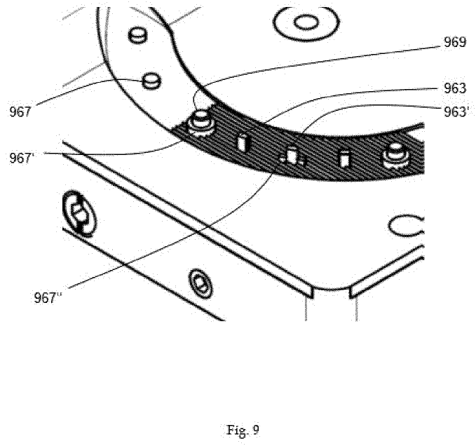

FIG. 7 and FIG. 8 show an injection molding die in two halves, fitting together, for a horseshoe for the fore leg. FIG. 7 shows the die half for the running surface side of the horseshoe, FIG. 8 shows the die half for the hoof side of the horseshoe. FIG. 9 furthermore shows a partial cutout of FIG. 8. In FIG. 7, the mold side 761 of the running surface (i.e., the bottom side of the horseshoe) is represented and in FIG. 8 the mold side 861 of the contact side (i.e., the hoof side of the horseshoe) is represented.

In the injection molding process, a horseshoe core (such as is represented in FIG. 3) is placed in a predetermined position in one of the two die halves (in the present example, practically in the mold side 861 of the contact side); after this, the two mold sides 761, 861 are fitted or pressed together, thereby securing the inserted core in its predetermined position. Functional layer material is injected into the resulting mold cavity. The injection mold die contains at least one intake 762, 862 for the functional layer material being injected.

The horseshoe has substantially a U shape, being possibly provided with holes 127 for horseshoe nails. Mold structures 763, 963, 963′ for horseshoe nails are provided in the mold halves 761, 861 running centrally in the mold. In the mold side 761 of the running surface, the mold structures 763 for the horseshoe nails are situated together with mold structures 765 for a groove, especially along and on the mold structures 765 of the groove.

In the mold side 861 of the bottom contact side, mold structure supports 967, 967′, 967″ and mold structure pins 969 are additionally formed for the supporting and/or positioning of the inserted core. Because the mold structure pins 969 and the mold structures 963, 963′ for horseshoe nails are longer in comparison to the mold structure support 967, 967′, 967″, the mold structure pins 969 and the mold structures 963, 963′ for horseshoe nails may protrude through the mold insert 351 at designated places 355. The mold structure supports 967, 967′, 967″ and mold structure pins 969 serve on the one hand for spacing apart the inserted core from the wall of the mold cavity, so that the core can be completely overmolded with the functional material, and on the other hand for securing the core in the mold cavity so that it does not shift or bend due to the injection pressure occurring during the injection molding.

Some of the mold structure supports 967′, 967″ are advisedly formed in combination with some of the mold structures 763, 963 for the horseshoe nails and/or with the mold structure pins 969 as locally combined mold structures. This is shown more clearly in FIG. 9, which shows an enlarged partial cutout of FIG. 8.

In the present case, the broadening mold structures 763 for horseshoe nails in the mold half 761 of the running surface form a counterpressure on the core. Alternatively, additional mold structure supports for the core (e.g., designed as support pins) could also be provided in this mold half 761.

In the following, the invention shall be explained with the aid of an example.

### Example

Especially good test results were shown by horseshoes containing a 2 mm thick core made from alternating carbon fiber and glass fiber layers embedded in a thermoplastic polycarbonate matrix, this core of fiber and PC matrix material being covered with a functional layer likewise made of thermoplastic polycarbonate, which is reinforced advantageously with short fibers. This ensures a minimal abrasion. The lifetime is over 6 weeks. The technical data for this especially advantageous horseshoe are as follows:
Core: carbon fiber and glass fiber layers in polycarbonate matrix (total around 2 mm thick)
Functional layer: polycarbonate with short fibers made of glass
Manufacture: 1. hot pressing method to produce the composite material of the core
   2. thermoplastic injection molding process for overmolding the core with functional layer material
Weight: around 60 grams (for size 6)
Use: cold fitting similar to horseshoes made of alternative material (such as aluminum), incl. possibility of hot deformation for individual adaptation to the particular horse' hoof
Benefits: —very light horseshoe (weight reduction around 50% compared to aluminum horseshoes)
   enhanced fracture resistance (especially as compared to plastic fiber composite horseshoes as disclosed in patent application CH710762 (A2))
   deformable or adaptable to the hoof shape by means of hot deforming, e.g., at temperatures around 140° C.

The horseshoes according to the invention are advisedly available in prefabricated sizes. However, the horseshoes can also be adapted to the individual hoof by means of hot deforming to a certain extent.

In summary, the horseshoe consists of a core made from a thermoplastic fiber composite (e.g., carbon fibers and/or glass fibers in a thermoplastic polycarbonate matrix) and a functional layer of a thermoplastic (such as a thermoplastic polycarbonate) sheathing the core. The functional layer may optionally be reinforced with fibers (such as glass fibers). The core matrix and the functional layer or the functional layer matrix comprise the same thermoplastic. The production method is injection molding.

### Alternative Embodiment

According to an especially easy and economical alternative embodiment, an advantageous horseshoe can be made from a fiber-reinforced thermoplastic polycarbonate material, containing 20 wt. % to 40 wt. % of glass fibers and 10 wt. % to 30 wt. % of carbon fibers. This material combination has proven to be especially economical, since it is possible to even do without a reinforcement by means of a core insert, which can make the production costs much lower. The fiber-reinforced thermoplastic polycarbonate material of the mentioned composition (with 20 wt. % to 40 wt. % glass fibers and 10 wt. % to 30 wt. % carbon fibers) may thus be formed on the one hand as the functional layer around a horseshoe core or on the other hand it may make up the major weight portion of the horseshoe as full material (i.e., for example, at least 80 wt. %, at least 90 wt. %, at least 95 wt. %, at least 98 wt. % or substantially 100 wt. %). In a slight weight portion, the horseshoe may contain inserts and/or attachments which are more abrasion resistant than the fiber-reinforced thermoplastic polycarbonate and which are placed on or embedded in the horseshoe such that they appear on the horseshoe surface in abrasion-endangered zones of the horseshoe (i.e., for example the horseshoe running surface and/or the horseshoe front edge adjacent to the horseshoe running surface) or form the horseshoe surface.

It has been found that glass fibers on the horseshoe surface act as an abrasion protection reinforcement. However, it has also been found that the fracture risk of the horseshoe may increase with a larger glass fiber fraction. However, it was surprisingly possible to arrest this tendency by the addition of carbon fibers, so that on the whole it is possible to create material properties (especially with regard to the desired rigidity and toughness) allowing the use of fiber-reinforced polycarbonate material as a horseshoe for racehorses.

The thermoplastic polycarbonate contains 25 wt. % to 35 wt. % of glass fibers and 15 wt. % to 25 wt. % of carbon fibers. Further, the thermoplastic polycarbonate contains 28 wt. % to 32 wt. % of glass fiber and 18 wt. % to 22 wt. % of carbon fiber. As mentioned above, this has the advantage that the resulting material properties are such that a light and stable horseshoe can be produced from fiber-reinforced thermoplastic polymer full material, meeting the requirements of horseracing.

A horseshoe of fiber-reinforced thermoplastic polycarbonate full material can likewise be made by injection molding. For this a fiber-reinforced thermoplastic polycarbonate material is used, which can be melted, e.g., at a temperature of 260° C. to 340° C., or at a temperature of 280° C. to 320° C.

The fiber-reinforced thermoplastic polycarbonate material is advisedly injected with a specific injection pressure of 800 bar to 1400 bar into the die.

The die is preheated, e.g., to 80° C. to 130° C., or to 80° C. to 120° C., before the molten fiber-reinforced thermoplastic polycarbonate material is injected.

Further, the fiber-reinforced thermoplastic polycarbonate material is previously dried before the melting, e.g., at 100° C. to 130° C., or at 100° C. to 120° C. The drying is normally done between 2 and 8 hours.

The injection molding die may be provided with abrasion protection elements, which are substantially surrounded with polymer material injected into the die during the injection molding and are thereby integrated into the horseshoe.

The production method is further characterized optionally in that a cooldown for the curing is performed after the injection molding of the horseshoe and after the curing the curvature of the horseshoe is adapted to a predetermined or desired fit by mechanical working or mechanical deformation, such as by pressing or pulling, at temperature elevated above room temperature, similar to what was described above in connection with the horseshoe with a core. The desired fit of the horseshoe can be adjusted by mechanical deformation at elevated temperature, in the range of 120° C. to 160° C., or in the range of 130° C. to 150° C.

This alternative embodiment will be explained below with the aid of an example.

### Example 2

Further good test results were shown by horseshoes made from fiber-reinforced thermoplastic polycarbonate (i.e. fiber-reinforced thermoplastic polycarbonate full material), which is reinforced with 30 wt. % glass fibers and 20 wt. % carbon fibers. The fibers used for this are advantageously short fibers. This ensures a minimal abrasion. The lifetime is over 6 weeks. The technical data for this especially advantageous horseshoe are as follows:
Material composition: polycarbonate matrix with short fibers made of glass and carbon: 50 wt. % polycarbonate with 30 wt. % glass fibers and 20 wt. % carbon fibers.
Manufacture: thermoplastic injection molding process
Weight: around 60 grams (for size 6)
Use: cold fitting similar to horseshoes made of alternative material (such as aluminum), incl. possibility of hot deformation for individual adaptation to the particular horse' hoof
Benefits: —very light horseshoe (weight reduction around 50% compared to aluminum horseshoes)
   enhanced fracture resistance (especially as compared to plastic fiber composite horseshoes as disclosed in patent application CH710762 (A2))
   deformable or adaptable to the hoof shape by means of hot deforming, e.g., at temperatures around 140° C.

While specific embodiments have been described above, it is obvious that different combinations of the indicated embodiment possibilities can be used, as long as the embodiment possibilities are not mutually exclusive.

While the invention has been described above with reference to specific embodiments, it is obvious that changes, modifications, variations and combinations can be made without departing from the idea of the invention.

1-30. (canceled)

31. A horseshoe for horses, comprising:
at least one thermoplastic polymer material, the thermoplastic polymer material including
at least one thermoplastic polycarbonate.

32. The horseshoe of claim 31, further comprising a core around which a functional layer is formed, wherein the functional layer is formed substantially from a fiber-reinforced thermoplastic polycarbonate.

33. The horseshoe of claim 32, wherein the core is formed substantially from a fiber-reinforced thermoplastic polymer material.

34. The horseshoe of claim 33, wherein the fiber-reinforced thermoplastic polymer material of the core is selected from the group consisting of thermoplastic polycarbonates.

35. The horseshoe of claim 33, wherein the fiber-reinforced thermoplastic polymer material of the core comprises fibers selected from the group consisting of carbon fibers, glass fibers, polymer fibers or combinations thereof.

36. The horseshoe of claim 33, wherein the fiber-reinforced thermoplastic polymer material of the core comprises long fibers or endless fibers.

37. The horseshoe of claim 33, wherein fibers of the fiber-reinforced thermoplastic polymer material of the core are arranged in one or more layers with the fibers of each layer forming a fabric.

38. The horseshoe of claim 37, wherein the core comprises a plurality of fiber layers arranged one on top of another, where one or more of the plurality of fiber layers comprise carbon fibers combined with one or more layers of glass fibers.

39. The horseshoe of claim 33, wherein the core comprises a plastic fiber composite plate.

40. The horseshoe of claim 31, wherein the at least one thermoplastic polycarbonate is fiber-reinforced.

41. The horseshoe of claim 32, wherein the functional layer is fiber-reinforced with at least one of carbon fibers or glass fibers.

42. The horseshoe of claim 41, wherein the at least one of carbon fibers or glass fibers comprise short fibers with a length of 0.01 mm to 1 mm.

43. The horseshoe of claim 32, wherein the fiber-reinforced polycarbonate comprises 10 wt. % to 80 wt. %.

44. The horseshoe of claim 32, wherein the functional layer comprises a combination of glass fibers and carbon fibers having 20 wt. % to 40 wt. % of glass fibers and 10 wt. % to 30 wt. % of carbon fibers.

45. The horseshoe of claim 42, further comprising an abrasion protection integrated into the horseshoe, the abrasion protection being more abrasion resistant than the at least one thermoplastic polymer material or more abrasion resistant than the functional layer.

46. A method for producing a horseshoe, comprising:
placing a core of fiber-reinforced thermoplastic polymer material in a mold; and
sheathing the core in a functional layer of a thermoplastic polycarbonate by injection molding.

47. The method of claim 46, further comprising melting on the functional layer material at a temperature of 260° C. to 340° C.

48. The method of claim 46, further comprising injecting the functional layer material into the mold with a specific injection pressure of 800 bar to 1400 bar.

49. The method of claim 48, further comprising heating the mold to a temperature between 80° C. and 130° C. before the functional layer material in molten form is injected.

50. The method of claim 47, further comprising drying the thermoplastic polycarbonate prior to melting at 100° to 130° C.

51. The method of claim 46, further comprising supporting the core at a spacing from molding surfaces inside the mold or in a fixed position within the mold.

52. The method of claim 46, further comprising providing an abrasion protection which provides an additional support structure for the core in the mold and is substantially encased in the fiber-reinforced thermoplastic polymer material to become integrated in the horseshoe.

53. The method of claim 46, wherein after the sheathing, the horseshoe is cooled down for curing and after the curing, a curvature of the horseshoe is adapted to a predetermined fit by mechanical deformation at a temperature of between 120° C. to 160° C.

54. The method of claim 46, further comprising shaping the horseshoe by injection molding.

55. The method of claim 46, further comprising melting the fiber-reinforced thermoplastic polymer material at a temperature of 260° C. to 340° C.

56. The method of claim 46, further comprising injecting the fiber-reinforced thermoplastic polymer material into the mold with a specific injection pressure of 800 bar to 1400 bar.

57. The method of claim 46, further comprising heating the mold to 80° C. to 130° C. before the molten fiber-reinforced thermoplastic polymer material is injected.

58. The method of claim 57, further comprising drying the fiber-reinforced thermoplastic polymer material prior to melting at 100° C. to 130°.

59. The method of claim 57, further comprising adapting the horseshoe at elevated temperatures in a range of 120° C. to 160° C. by mechanical deformation to a shape of a hoof being shod.
